(19) United States
(12) Patent Application Publication
(10) Pub. No.: US 2009/0277590 A1
(43) Pub. Date: Nov. 12, 2009

(54) Device and method for corona treatment of flat material

(75) Inventors: Joachim Jung, Nurtingen (DE); Bernd Schwarz, Nurtingen (DE); Oliver Treichel, Stuttgart (DE); Peter Holl, Tubingen (DE)

Correspondence Address: COLLARD & ROE, P.C., 1077 NORTHERN BOULEVARD, ROSLYN, NY, 11576, US

(73) Assignee: IST METZ GmbH

(21) Appl. No.: 11/919,290

(22) PCT Filed: Apr. 28, 2006
(86) PCT No.: PCT/EP2006/003952

§ 371 Date: Oct. 25, 2007

(30) Foreign Application Priority Data
May 4, 2005 (DE) 10 2005 021 876.8

(51) Int. Cl. B32B 38/00; B05D 3/14; B29C 59/10

(52) U.S. Cl. 156/379.6; 118/620; 425/174; 427/540; 264/446; 156/272.6

(57) ABSTRACT

The invention relates to a device and a method for the corona treatment of flat material (30) using a cylindrical transport electrode (1) that can be rotated in such a way as to transport the flat material, a treatment electrode (2a,b) which is arranged opposite the transport electrode (1) and defines a treatment gap (31) for the flat material (30), a high-voltage source (4) for applying a high-frequency electrical voltage to the treatment electrode (2a, b), and sheet holders (11) which are arranged on the envelope side of the transport electrode (1) and used to receive the edges of sheets of flat materials (30). The inventive device is characterized by a treatment device (12) wherein blowing means (22, 23) are embodied or arranged in front of, and behind, at least one treatment electrode (2a, 2b), in the direction of transport (32). A gaseous medium (16, 17) can be guided through the blowing means towards the flat material (30) located in the treatment gap (31) in such a way that it lies in a plane manner on the envelope surface of the transport electrode (1) at least in the region of the treatment gap (31).

The invention relates to a device and a method for corona treatment of flat material in sheet form, having a roller-shaped transport electrode that can be rotated to transport the flat material, a treatment electrode disposed relative to the transport electrode so as to define a treatment gap for the flat material, a high-tension source to apply a high-frequency electrical voltage to the treatment electrode, and having sheet grippers disposed on the transport electrode, on the mantle side, to accommodate the edges of sheets of flat material.

Corona treatment is a technology that is known in the printing industry, in which materials in the form of webs or sheets are pre-treated or modified by means of electrical discharge on their surface. The goal of the treatment is to functionalize the material surface in such a manner that advantageous properties for subsequent process steps, such as imprinting, laminating, or gluing, can be achieved, particularly good adhesion of coating agents even on substrates that are actually not non-polar. In the case of treatment of moving webs, the web material is guided through a treatment gap or discharge gap, the gap width of which typically lies in the range of a few millimeters. In this connection, the gap width is composed of the thickness of the material web and a gap above the surface of the latter, which is to be treated.

Particularly in the further processing of web materials kept on hand in the form of individual sheets in stacks, there is the problem that the advantageous effects of the corona treatment change over time, or actually disappear completely, so that undesirable quality variations must be expected during the production sequence. It is therefore disadvantageous to put corona-treated flat material down or to roll it up, and subsequently to put it into intermediate storage, particularly since it cannot be reliably prevented that these layers adhere to one another. In contrast, it is desirable to further process the corona-treated flat materials in product-specific manner immediately after they are treated, in other words to imprint them or to provide them with a varnish layer, for example.

A device for corona treatment of imprintable flat material sheets, for example, is known from DE 100 39 073 A1. This reference deals specifically with solving the problem of how it can be made possible for a transport electrode configured as a roller to pass by the sheet grippers, without being harmed, despite the technical general conditions for corona production that limit the height of the treatment gap. For this purpose, an adjustment device is provided, with which the gap width of the treatment gap is made possible between a working position and a gripper pass-through position, as a function of the revolution of the sheet gripper.

With this background, the invention is based on the task of presenting a device of the type stated, as well as a method in this regard, for corona treatment of flat materials, which device can be produced in comparatively cost-advantageous manner and which device and method guarantee reliable operation and a high level of treatment quality. The device is furthermore supposed to be suitable for being involved in printing tasks.

The solution for this task results from the characteristics of the independent claims, while advantageous embodiments and further developments of the invention can be derived from the related dependent claims, in each instance.

Accordingly, the device according to the invention has a corona treatment device configured as a sheet hold-down device, in which the at least one treatment electrode is disposed, and in which blowing means are disposed or configured in front of and behind the at least one treatment electrode, seen in the transport direction, by means of which blowing means a gaseous medium can be conducted onto the flat material situated in the treatment gap, in such a manner that this material lies on the mantle surface of the transport electrode in flat or planar manner, at least in the region of the treatment gap. In this manner, corona treatment on one side, without undesirable back-side effects, can be achieved.

The invention is based on the recognition that the technical problems described, particularly those of allowing passage of the sheet grippers through the treatment gap, can be solved in relatively simple manner if the height of the treatment gap is constantly kept at the dimension required for this purpose. However, this requires special measures in connection with the voltage supply and the voltage control of the at least one treatment electrode, as well as in connection with holding the flat material sheet down in the treatment gap, particularly at the end of the material sheet.

The clearly larger treatment gap for allowing passage of the sheet grippers, as compared with known devices and methods, can be bridged by means of a corona discharge between the at least one treatment electrode and the counter-electrode, by means of a special control method for the voltage supply of the at least one treatment electrode; this will be discussed further below.

Preferably, the treatment device according to the invention has at least two treatment electrodes that are elongated crosswise to the transport direction, approximately in rod shape or cylinder shape, which are disposed parallel next to one another. A comparatively long corona treatment distance, seen in the transport direction, is created by means of this measure, which distance also allows greater transport speeds for the flat material in sheet form, for example.

According to another characteristic of the invention, it is provided that the at least one treatment electrode is disposed in an electrode chamber within the treatment device. This electrode chamber is essentially formed by a housing that serves to accommodate the at least one treatment electrode, but also permits a cooled gas stream to be passed by the latter, in targeted manner.

In another embodiment of the invention, it can be provided that at least one suction channel for suctioning gaseous media out of the treatment gap is formed in the treatment device. Such gaseous media can contain ozone, which is harmful to the environment, for example, which is formed during the corona treatment and can be suctioned out of the treatment gap in targeted manner by means of this structure. Preferably, this medium is passed close by the electrodes, so that these are cooled.

According to another further development of the invention, it is therefore provided that the at least one suction channel is connected with the interior of the electrode chamber by way of at least one opening.

Another important variant of the invention provides that the treatment device has at least one feed channel for feeding a gaseous medium to the treatment gap. In the simplest case, this gaseous medium is ambient air, but also such gases that assure neutralization of the ozone formed in the treatment gap or can entirely prevent its formation can be guided onto the flat material in sheet form, in targeted manner.

Already at this point, it should be pointed out that the gas stream that can be guided onto the flat material by means of the at least one feed channel, according to the invention, is utilized to securely press the flat material onto the mantle surface of the transport electrode, particularly in planar manner, as it passes through the treatment gap. This is of particular advantage for the end region of the flat material in sheet form, in particular.

In another embodiment, it is provided that the at least one suction channel forms the inside walls of at least two feed channels for the gaseous medium, so that these channels can be produced in cost-advantageous manner and so that they have a small build.

Furthermore, it can be provided that openings are formed between the at least one treatment electrode and the walls of the electrode chamber and/or between the individual treatment electrodes, through which the gaseous medium can be suctioned in from the treatment gap into the interior of the treatment chamber. By means of this measure, the medium suctioned in passes completely over the treatment electrodes.

The blowing means preferably have blow-out nozzles that connect the at least one feed channel with the treatment gap, preferably pointing radially to the transport electrode.

It is advantageous if the blowing means are configured separately for example as perforated plates, and connected with the housing of the treatment device in such a manner that electrical arcing of the electrodes is avoided. In this connection, it is also advantageous if the blowing means are adapted to the circumference geometry of the transport electrode, at least on their side facing towards the transport electrode, in other words are configured to be slightly cylindrical.

Another characteristic of the invention is that the blowing means, which are held fixed in place, have radial recesses on their side facing the transport electrode, which recesses are disposed and configured in such a manner that the sheet grippers of the transport electrode can be passed through under the treatment device when the transport electrode rotates, without any change in the height of the treatment gap. These recesses are configured as grooves, for example, and are disposed on the blowing means lying parallel next to and at a distance from one another.

In a concrete embodiment of the invention, it can be provided that the air gap within the treatment gap for the flat material in sheet form has a height of 1 mm to 2 mm, and the distance between the treatment electrodes and the mantle surface of the transport electrode amounts to 5 mm to 10 mm, preferably more than 7 mm. Distances between 5 and 7 mm, in particular, are preferred so that the sheet grippers can be passed through without problems.

It is advantageous if the treatment device is integrated into the sheet printing machine as an individual unit or insert, whereby the counter-pressure cylinder of the sheet printing machine forms the transport electrode, ahead of the first printing unit, and this can perform two functions in the printing process.

Since the treatment device for corona treatment of the flat material is now structured in comparatively simple manner mechanically, and so as to save space, and does not have any radially movable components, this corona treatment system can be installed into an existing conventional printing machine, in complete form, so that the latter can subsequently be utilized as a corona-treating printing machine.

The treatment device has a voltage supply and control device assigned to it, which has an electrical generator for supplying the voltage to the treatment electrodes, a timing pulse generator for the electrode voltage, an interruption control for the electrode voltage, a transformer for producing the electrical high voltage, as well as control and regulation means for sheet transport control and for control and regulation of gas pumps.

In this connection, it is preferably provided that the interruption control stands in connection with a sensor, in terms of signal technology, with which sensor the position of at least one sheet gripper on the transport electrode can be detected as the latter rotates.

Furthermore, it is considered to be advantageous if the timing pulse generator is connected with a setting means for setting the pulse duration and with a setting means for setting the pulse pause duration of the cycled electrical voltage for the at least one treatment electrode. Using these devices, the aforementioned parameters can be set as a function of the material thickness and the material properties of the flat structure, as well as of the speed of rotation of the transport electrode, in such a manner that despite the fact that the gap height is great enough to allow the sheet grippers to pass through the treatment gap without being damaged, an effective corona discharge occurs between the electrodes, and overheating of the treatment electrodes is avoided.

In another embodiment of the device according to the invention, it is provided that the at least one feed channel for the gaseous medium is connected with a gas pump that can make such a gas stream for blowing means available, controlled by the voltage supply and control device, that both the entire sheet and thus also the end of the sheet of flat material lies flat on the mantle surface of the treatment electrode when it passes through the treatment gap.

In addition, it can be provided that the at least one suction channel is connected with a gas pump with which the gas stream suctioned in can be guided to an ozone conversion device, controlled by the voltage supply and control device. There, the ozone-carrying, suctioned medium is converted into gases that are not harmful to the environment.

For precise control and/or regulation of the two gas pumps, a pressure sensor is preferably disposed in the region of the treatment gap, which sensor is connected with the voltage supply and control device by way of a sensor line, for example.

Finally, in addition or alternatively to the stated gas feed device, a gas suction device can also be formed in the transport electrode, with which flat materials, even those that are particularly thick, can be held on the transport electrode in planar manner. This gas suction device comprises radial bores in the mantle surface of the transport electrode, which are connected with a gas pump by way of at least one gas line. This gas pump produces a partial vacuum in the region of the mantle surface of the transport electrode, at least in the region of the treatment gap, which allows the flat material to temporarily adhere to the mantle surface particularly well.

In terms of method, the task stated initially is accomplished in that a gaseous medium is passed onto the flat material situated in the treatment gap, by means of blowing means disposed in front of and behind the at least one treatment electrode, seen in the transport direction, in such a manner that this material lies flat on the mantle surface of the transport electrode, at least in the region of the treatment gap, and is corona-treated only on its top that faces the treatment electrode.

To accomplish the stated task, the invention also relates to a method for controlling a device according to at least one of the aforementioned characteristics. In this method, it is provided that the voltage supply of the at least one treatment electrode takes place in such a manner that electrical discharges for corona treatment of flat materials, over a distance of more than 5 mm between the at least one treatment electrode and the transport electrode, as well as over a width of 10 mm to at least 2000 mm, can be achieved in the treatment gap at atmospheric pressure, by means of a combination of the amplitude height of the electrical voltage, its frequency, is pulse shape, pulse length, pulse pause length, and flank shape, in combination with an impedance adjustment by means of suitable cable laying and cable lengths as well as of the electrodes, which combination relates to the application case, and is dependent, among other things, on the dielectric properties of the flat material.

Furthermore, the method provides, in one variant, that the voltage supply for the at least one treatment electrode is interrupted if a sheet gripper was sensed in the region of the treatment device. In this way, a negative influence on the pre-treatment is prevented.

A particularly important characteristic of the method provides that the sheet grippers are passed through, without hindrance, during rotation of the transport electrode, through recesses in the blowing means, which are held fixed in place.

In order to reliably assure that the flat material lies flat on the mantle surface of the transport electrode as it passes through the treatment gap, it is proposed that the gaseous medium is guided radially against the transport electrode by way of the blowing means.

At the same time, the pump output of the gas pump for suctioning off the gaseous medium from the treatment gap can be controlled or regulated in such a manner that on the one hand, gas that is harmful to the environment is passed away from the treatment gap, and, on the other hand, the press-down function of the gas stream from the blowing means onto the flat material is not impaired. For this purpose, it is possible to refer to sensor data or a pressure sensor in this regard, which sensor measures the gas pressure in the treatment gap or at least in the region of the latter.

A concrete exemplary embodiment of the invention is shown in the attached drawing. This shows:

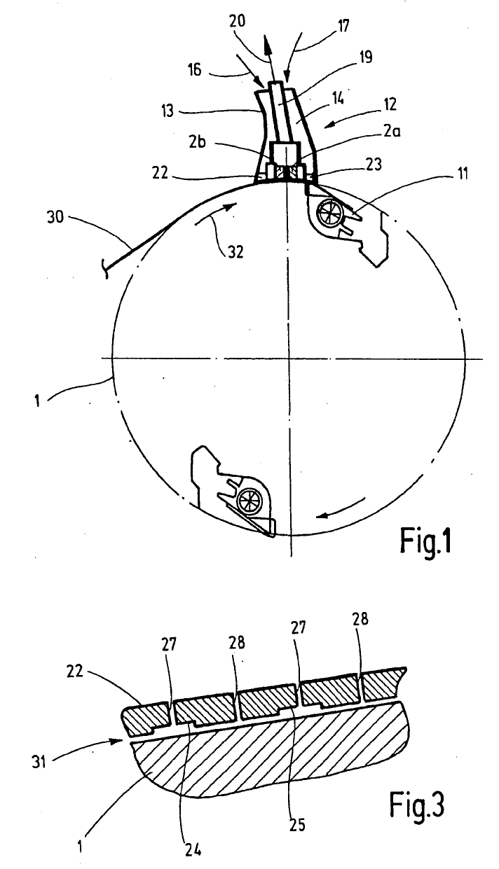

FIG. 1 an overview representation of a corona treatment device according to the invention,

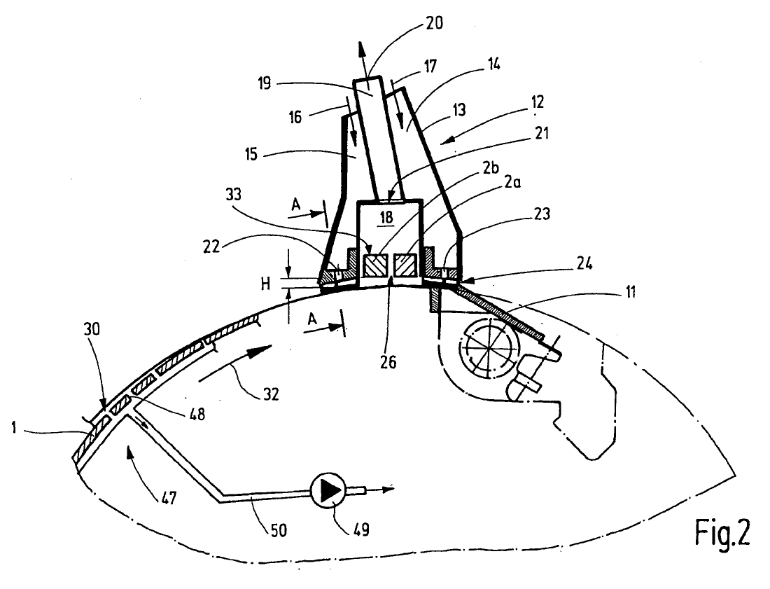

FIG. 2 an enlarged detail representation of the corona treatment device according to FIG. 1,

FIG. 3 a representation of the partial section A-A according to FIG. 2,

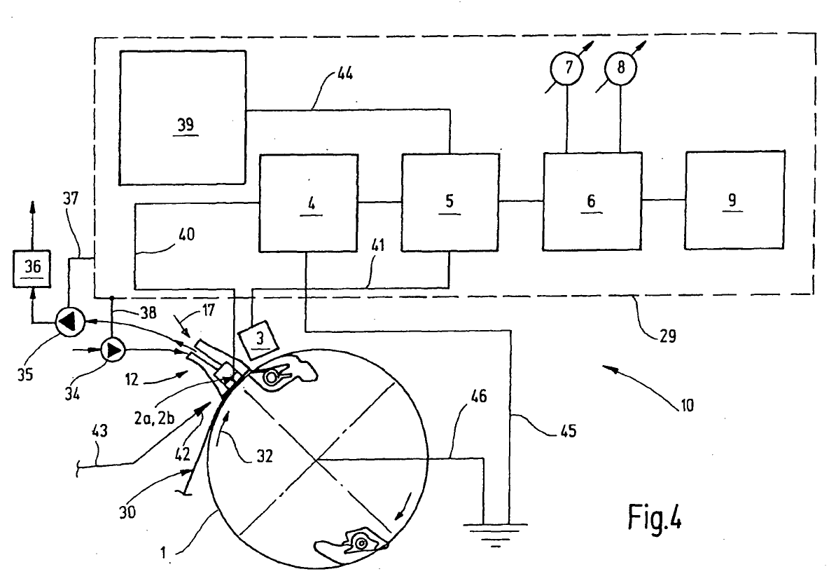

FIG. 4 a schematic representation of a corona treatment system having the corona treatment device according to FIGS. 1 to 3, as well as having voltage supply and control and regulation devices,

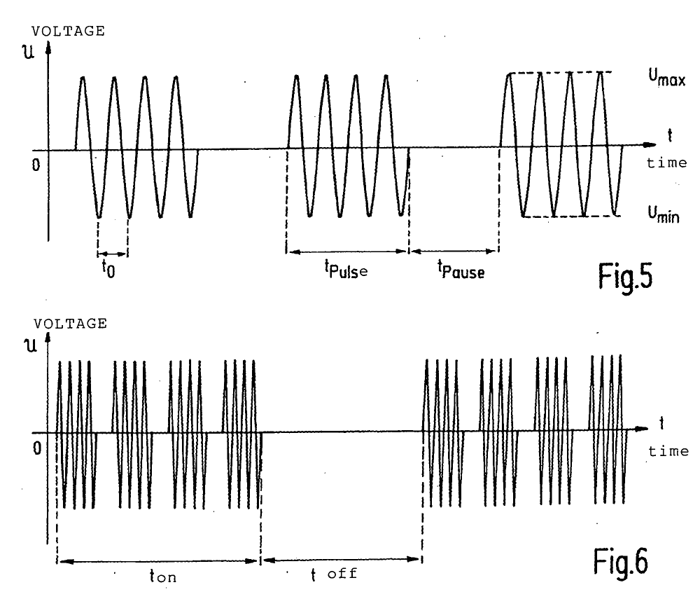

FIG. 5 as an example, a cycled voltage progression over time for the supply of treatment electrodes, and

FIG. 6 as an example, a cycled progression of interruptions in the voltage supply according to FIG. 5.

Accordingly, an important part of a system 10 for corona treatment of flat materials in sheet form, according to the invention, is schematically shown in FIG. 1. The device first of all comprises a transport electrode 1 in the form of a roller, which also serves as a counter-pressure cylinder of a sheet printing machine, which electrode is equipped with sheet grippers 11 in the region of its mantle surface, in known manner. Using these sheet grippers 11, a sheet 30, here a sheet to be treated before a printing process, by means of corona discharge, having a thickness of up to 0.8 mm, is clamped in the transport electrode 1, in such a manner that it can be moved through under a treatment device 12.

As the detail representations of FIGS. 2 and 3 illustrate, the treatment device 12 first of all comprises an elongated housing 13, in which an electrode chamber 18 is configured. Two elongated electrodes 2a and 2b are disposed in this electrode chamber 18; they are supplied with a cycled high voltage by a voltage supply and control device 29. This high-voltage supply will be discussed further below, in connection with FIG. 4.

Another important innovation of this treatment device 12 is now that in this device, the treatment electrodes 2a, 2b are disposed so far removed form the mantle surface of the transport electrode 1 that the sheet grippers 11, which partly project radially beyond this mantle surface and the flat material 30 to be held, can pass by the treatment device 12 without any movement of the latter, and without damage. The treatment device 12 is therefore disposed at such a distance from the flat material 30 that it does not press the flat material 30 mechanically against the transport electrode 1.

In order to nevertheless assure that the flat material 30 in sheet form lies flat on the transport electrode 1 during its entire passage through the treatment gap 31 formed between the transport electrode 1 and the treatment device 12, the treatment device 12 has a holding system operated with compressed gas. This holding system comprises at least two feed channels 14, 15 for a gaseous medium 16 or 17, respectively, whereby this medium can be air, in the simplest case. Upstream, the feed channels 14, 15 are connected with a gas pump 34 that conveys the gaseous medium 16, 17, and downstream, they end essentially perpendicular relative to the mantle surface of the treatment electrode 1. By means of the gas stream or blowing air directed at the flat material 30, the latter is held flat on the mantle surface of the transport electrode 1 during the entire corona treatment process in the treatment gap 31.

This hold-down device for the flat material 30 functions in particularly advantageous manner if a gas jet impacts the flat material in front of and behind the two treatment electrodes 2a, 2b, in each instance, in the transport direction 32. In this way, it is ensured, particularly when the free end of the flat material sheet 30 is passed by underneath the treatment electrodes 2a, 2b, that not even this region lifts off from the transport electrode 1.

According to another advantageous detail, the treatment device 12 has a blowing means 22 or 23 situated ahead of or behind the two treatment electrodes 2a, 2b, respectively, at the downstream end of the two feed channels 14, 15, which means are configured, here, as separately produced perforated sheets connected with the housing 18. However, these blowing means 22, 23 can also be an integral component of the housing 13, 18 of the treatment device 12, in other words can be formed from a sheet-metal blank after it is punched, by means of a forming process, together with the remainder of the housing 18.

Separately produced blowing means 22, 23 are advantageously configured to be interchangeable, so that different blowing means 22, 23 can be provided for flat materials 30 of different types, having different thicknesses or being made of different materials. In this connection, the number of the blow-out nozzles 27 or 28 formed in the blowing means 22, 23, their shape, orientation, and diameter, will vary, in particular.

With regard to the formation of the blowing means 22, 23 and the blow-out nozzles 27, 28, reference is made, in particular, to FIG. 3. There, it is shown, in a schematic partial section A-A from FIG. 2, that in the simplest case, the blow-out nozzles 27, 28 are configured as radial bores in the blowing means 22, 23. The blow-out nozzles 28 open directly into the treatment gap 31 already mentioned, while other blow-out nozzles 27 open into recesses 24 for the sheet grippers 11, which are provided in the blowing means 22, 23, in this exemplary embodiment, to reduce the required height between the radial underside of the treatment electrodes 2a, 2b and the mantle surface of the transport electrode 1.

As can be further seen in FIG. 2, the invention provides, in another advantageous variant, that at least one suction channel 19 is integrated into the housing 18 of the treatment device 12. At the same time, the walls of this at least one suction channel 19 form inside walls of the feed channels 14, 15. The suction channel 19 is connected with the interior of the electrode chamber 18 by way of an opening 21, at its upstream end. In addition, the treatment electrodes 2a and 2b are disposed in the treatment chamber 18 in such a manner that a gap 26 is formed between them, and openings 33 are formed between them and the walls of the treatment chamber 18.

A gaseous medium 20 situated in the treatment gap can be suctioned in through this gap 26 or these openings 33, respectively, into the treatment chamber 18, and from there into the suction channel 19, by way of the opening 21. Since air situated in the treatment gap during the corona discharge experiences ozone enrichment, this air must be suctioned off from the treatment gap 31, in targeted manner, and neutralized, according to another aspect of the invention. For this purpose, the suction channel 19 is connected with an ozone conversion device 36 by way of a suction pump 35, in which device a gas 20 that contains ozone, drawn off from the treatment gap 31, can be converted into a gas that is not harmful for the environment.

By means of the formation of the gap 26 between the two treatment electrodes 2a and 2b, as well as of the openings 33 between the treatment electrodes 2a, 2b, and the inside walls of the electrode chamber 18, the gas stream guided by them is also advantageously utilized to cool the treatment electrodes 2a, 2b.

Additional means can be seen in FIG. 2, with which it can be ensured that even particularly thick flat materials lie flat on the surface of the transport electrode 1 during the corona treatment, even without any mechanical pressure being applied. For this purpose, a gas suction device 47 is integrated into the transport electrode 1, in addition to or alternatively to the aforementioned gas blowing device 34, 14, 15, 22, 23. This gas suction device 47 comprises radial bores 48 in the mantle surface of the transport electrode 1, which are connected with a gas pump 49 by way of at least one gas line 50. This gas pump 49 produces a partial vacuum in the region of the mantle surface of the transport electrode 1, which allows the flat material 30 to temporarily adhere particularly well to the latter.

As FIG. 4 illustrates, the voltage supply and control device 29, which was already mentioned, serves not only to supply voltage for the two treatment electrodes 2a, 2b, but also to control and regulate all of the device components relevant here. For this purpose, a suitable control and regulation means 39, for example a computer with analog/digital converter, is present in this device.

The two aforementioned gas pumps 34 and 35 also belong to the devices of the treatment system 10 according to FIG. 4 that are to be controlled or regulated; for this purpose, they are connected with the voltage supply and control device 29 by way of control lines 37 and 38, respectively. The pumps 34, 35 are regulated in operation, using sensor data or a pressure sensor 42, in such a manner that on the one hand, such a gas stream is blown into the treatment gap 31 that the flat material 30 lies flat on the mantle surface of the transport electrode 1 during the entire passage of the flat material 30 through the gap, and, on the other hand, as much as possible of the gas 20 that contains ozone is suctioned out of the treatment gap 31. For this purpose, the pressure sensor 42 measures the gas pressure at least in the region of the treatment gap 31, but preferably in the gap itself, and is connected with the control and regulation means 39 by means of a sensor line 43.

FIG. 4 furthermore shows that the voltage supply and control device 29 also has an electrical generator 9 that produces the feed voltage for the two treatment electrodes 2a, 2b, in a suitable amount. This electrical voltage U is cycled by means of a timing pulse generator 6, which can be adjusted manually or under computer control, by means of setting devices. In this connection, a setting device 7 serves to set the time length tₚᵤₗₛₑ of voltage pulses, and a setting device 8 serves to set the time length tₚₐᵤₛₑ of interruptions in the voltage supply.

In addition, an interruption control 5 is integrated into the voltage supply and control device 29, and preferably connected with the control and regulation means 39 by way of a data line or control line 44. The voltage supply for the two treatment electrodes 2a, 2b can be interrupted by means of this interruption control 5, over a time period t_{off} that is clearly longer than the aforementioned time period tₚₐᵤₛₑ. The time period t_{off} is set to be as long as the grippers need to move through underneath the treatment electrodes 2a, 2b.

For precise control of the interruption time period t_{off} by means of the interruption control 5, a measurement value of a sensor 3 is used, with which the position of at least one of the sheet grippers 11 with reference to the treatment device 12 can be determined. For this purpose, this sensor 3 is connected with the interruption control 5 by way of a sensor line 41.

The electrical voltage U cycled by the devices 5 and 6 can then be passed to a transformer 4, which transforms same into a suitable high voltage. From there, this cycled high voltage gets to the two treatment electrodes 2a, 2b by way of a line 40. The transformer 4 and the transport electrode 1 are grounded by way of lines 45 and 46.

FIGS. 5 and 6 show the progression of the cycled high voltage U over the time t, as an example. In this connection, it is provided, according to the invention, that the voltage supply of the at least one treatment electrode 2a, 2b takes place in such a manner that electrical discharges for corona treatment of flat materials 30 can be implemented over a distance of more than 5 mm as well as a width of 10 mm to at least 2000 mm, by means of a combination, with reference to an application case, of the amplitude height (maximal voltage Uₘₐₓ, minimal voltage Uₘᵢₙ) of the electrical voltage U, its frequency t₀, its pulse shape, pulse length tₚᵤₗₛₑ, pulse pause length tₚₐᵤₛₑ, and its flank shape, in connection with an impedance adjustment by means of suitable cable laying and cable length of the electrical lines in question, as well as of the electrodes in the treatment gap 31, at atmospheric pressure.

Looking at FIG. 5 and FIG. 6 together makes it clear that a sum of many individual pulses having the length tₚᵤₗₛₑ and individual pauses tₚₐᵤₛₑ results in a switch-on time tₒₙ during one rotation of the transport electrode 1. This switch-on time tₒₙ is then followed by the switch-off time t_{off}, which describes that period of time that the sheet holders 11 need for moving past below the treatment electrodes 2a, 2b.

The above explanations make it clear that a device having an extremely simple mechanical configuration is created with the corona treatment system 10 that has been presented, by means of which even comparatively thick flat materials 30 in sheet form can be corona-treated, without its being necessary to press them mechanically against the transport electrode 1.

1. Device for corona treatment of flat material (30) in sheet form, having a roller-shaped transport electrode (1) that can be rotated to transport the flat material, a treatment electrode (2a, 2b) disposed relative to the transport electrode (1) so as to define a treatment gap (31) for the flat material (30), a high-tension source (4) to apply a high-frequency electrical voltage to the treatment electrode (2a, 2b), and having sheet grippers (11) disposed on the transport electrode (1), on the mantle side, to accommodate the edges of sheets of flat material (30), comprising a treatment device (12) configured to hold down sheets that pass through, in which device the at least one treatment electrode (2a, 2b) is disposed, and in which device blowing means (22, 23) are disposed in front of and behind the at least one treatment electrode (2a, 2b), seen in the transport direction (32), by means of which blowing means a gaseous medium (16, 17) can be conducted onto the flat material (30) situated in the treatment gap (31), in such a manner that this material lies on the mantle surface of the transport electrode (1) in flat manner, at least in the region of the treatment gap (31).

2. Device according to claim 1, wherein at least two elongated treatment electrodes (2a, 2b) are disposed in the treatment device (12).

3. Device according to claim 1, wherein the at least one treatment electrode (2a, 2b) is disposed in an electrode chamber (18) within the treatment device (12).

4. Device according to claim 1, wherein the treatment device (12) has at least one feed channel (14, 15) for feeding the gaseous medium (16, 17) to the treatment gap (31).

5. Device according to claim 1, wherein at least one suction channel (19) for suctioning gaseous media (20) out of the treatment gap (31) is formed in the treatment device (12).

6. Device according to claim 5, wherein the suction channel (19) is connected with the interior of the electrode chamber (18) by way of at least one opening (21).

7. Device according to claim 5, wherein the inside walls of the feed channels (14, 15) delimit the suction channel (19).

8. Device according to claim 1, wherein the treatment electrode (2a, 2b) produces a corona treatment only on the side of the flat material sheets that faces it, while the sheet back side that lies on the transport electrode (1) remains untreated.

9. Device according to claim 4, wherein the blowing means (22, 23) have blow-out nozzles (27, 28) that connect the at least one feed channel (14, 15) with the treatment gap (31), facing towards the transport electrode (1).

10. Device according to claim 1, wherein openings (33) or gaps (26) are formed between the at least one treatment electrode (2a, 2b) and the walls of the electrode chamber (18) and/or between the individual treatment electrodes (2a, 2b), through which openings or gaps a gaseous medium can be suctioned from the treatment gap (31) into the interior of the treatment chamber (18).

11. Device according to claim 1, wherein the blowing means (22, 23) are fixed in place at a distance from the mantle surface of the transport electrode (1), and are provided with recesses (24, 25) for allowing the sheet grippers (11) to pass through.

12. Device according to claim 11, wherein the blowing means (22, 23) have the recesses (24, 25) on their side pointing towards the transport electrode (1), whereby the recesses (24, 25) are disposed and configured in such a manner that the sheet grippers (11) can be passed through below the treatment device (12) during a rotation of the transport electrode (1), without any change in the height of the treatment gap (31).

13. Device according to claim 1, wherein the air gap in the treatment gap (31) has a height of 1 mm to 2 mm, and that the distance (H) of the treatment electrodes (2a, 2b) from the mantle surface of the transport electrode (1) amounts to 5 mm to 10 mm, preferably more than 7 mm.

14. Device according to claim 1, wherein the treatment device (12) is integrated into a sheet printing machine as an insert unit.

15. Device according to claim 1, wherein the counter-pressure cylinder of a sheet printing machine, ahead of the first printing unit, forms the transport electrode (1).

16. Device according to claim 1, wherein a voltage supply and control device (29) is assigned to it, which has an electrical generator (9), a timing pulse generator (6) for the electrode voltage (U), an interruption control (5), a transformer (4), as well as control and regulation means (39) for sheet transport control and for control and regulation of gas pumps (35, 36).

17. Device according to claim 16, wherein the interruption control (5) stands in connection with a sensor (3) with which the position of at least one sheet gripper (11) can be detected.

18. Device according to claim 16, wherein timing pulse generator (6) is connected with a setting means (7) for setting the pulse duration (tₚᵤₗₛₑ) and with a setting means (8) for setting the pulse pause duration (tₚₐᵤₛₑ) of the electrical voltage (U) for the at least one treatment electrode (2a, 2b).

19. Device according to claim 1, wherein the at least one feed channel (14, 15) is connected with a gas pump (34) that can make such a gas stream (16, 17) available, controlled by the voltage supply and control device (29), that both the start of the sheet and the end of the sheet of flat material (30) lies flat on the mantle surface of the treatment electrode (1).

20. Device according to claim 1, wherein the at least one suction channel (19) is connected with a gas pump (35) with which the gas stream (20) suctioned in can be passed to an ozone conversion device (36).

21. Device according to claim 1, wherein a pressure sensor (42) is disposed in the region of the treatment gap (31) and connected with the voltage supply and control device (29) in terms of signal technology.

22. Device according to claim 1, wherein a suction device (47) for the flat material (30) is formed on the transport electrode (1), in such a manner that radial bores (48) in the mantle of the transport electrode (1) are connected with a suction pump (49).

23. Sheet printing machine having a device according to claim 1 integrated ahead of the first printing unit.

24. Method for corona treatment of flat material (30) in sheet form, in which the flat material sheets are transported by way of a transport electrode (1) in roller form that can rotate, in a transport direction, whereby the flat material sheets (30) are subjected to corona treatment in a treatment gap (31), by means of at least one treatment electrode (2a, 2b) disposed opposite the transport electrode (1), wherein a gaseous medium (16, 17) is passed onto the flat material (30) situated in the treatment gap (31), by means of blowing means (22, 23) disposed in front of and behind the at least one treatment electrode (2a, 2b), seen in the transport direction (32), in such a manner that this material lies flat on the mantle surface of the transport electrode (1), at least in the region of the treatment gap (31), and is corona-treated only on its top that faces the treatment electrode (2a, 2b).

25. Method for control of a device according to claim 1, wherein the voltage supply of the at least one treatment electrode (2a, 2b) takes place in such a manner that at atmospheric pressure, electrical discharges for corona treatment of flat materials (30) take place over a distance of more than 5 mm between the at least one treatment electrode (2a, 2b) and the transport electrode (1).

26. Method according to claim 24, wherein the voltage supply for the at least one treatment electrode (2a, 2b) is interrupted if a sheet gripper (11) is sensed in the region of the treatment device (12).

27. Method according to claim 24, wherein the sheet grippers (11) are passed through, without hindrance, as the transport electrode (1) rotates, through recesses of the blowing means (22, 23) that are held fixed in place.

28. Method according to claim 24, wherein the gaseous medium is guided radially against the transport electrode (1), by way of the blowing means (22, 23), in such a way that the flat material (30) lies flat on the mantle surface of the transport electrode (1) as it passes through the treatment gap (31).
